(19) United States
(12) Patent Application Publication
(10) Pub. No.: US 2024/0419976 A1
(43) Pub. Date: Dec. 19, 2024

(54) SYSTEMS AND METHODS FOR ENHANCING THE PERFORMANCE OF A LARGE LANGUAGE MODEL USING LOCAL EXECUTION

(71) Applicant: Idealab Studio, LLC, Pasadena, CA (US)

(72) Inventor: William Tod Gross, Pasadena, CA (US)

(21) Appl. No.: 18/739,205

(22) Filed: Jun. 10, 2024

Related U.S. Application Data
(60) Provisional application No. 63/507,819, filed on Jun. 13, 2023.

(51) Int. Cl. G06N 3/0895

(52) U.S. Cl. CPC G06N 3/0895

(57) ABSTRACT

A system and method are configured to receive a pre-trained large learning model via the network interface, access user data stored locally, train the pre-trained large learning model using the locally stored user data to provide an enhanced local large learning model, detect that a browser hosted by the computer system is accessing a webpage, identify a webpage space configured to receive third-party content, examine the webpage to determine if content provided by the enhanced, local large learning model may be rendered at the webpage space, and causing content generated or selected by the enhanced, local large learning model to be rendered at the webpage space. The enhanced local large learning model may comprise a neural network.

### BACKGROUND OF THE INVENTION

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### COPYRIGHT NOTICE

A portion of the disclosure of this patent document contains material which is subject to copyright protection. The copyright owner has no objection to the facsimile reproduction by anyone of the patent document and/or the patent disclosure as it appears in the United States Patent and Trademark Office patent file and/or records, but otherwise reserves all copyrights whatsoever.

### BACKGROUND

### Field of the Invention

The present disclosure relates to large language models and enhancing the performance thereof.

### Description of the Related Art

Large language models are becoming an increasingly important technology with respect to generating content, providing answers to questions, summarizing information, generating human-like text, performing translations, and/or the like. LLMs may thus be utilized in many different types of applications, such as chatbots, language processing, and content creation.

Disadvantageously, large language models may not always provide the desired output or a fully informed output, wasting computer resources and user time. LLMs suffer from such deficits because they are based on statistical patterns in vast amounts of language data, and their output is no better than the data the LLMs were trained on.

In addition, because LLMs are hosted on systems remote from user devices, the response time to queries or other content requests from user devices may be disadvantageously slow. The response time of an LLM may further be slowed by having to process and respond to content requests from large numbers of user devices at the same time.

### BRIEF DESCRIPTION OF THE DRAWINGS

While each of the drawing figures illustrates a particular aspect for purposes of illustrating a clear example, other embodiments may omit, add to, reorder, and/or modify any of the elements shown in the drawing figures. For purposes of illustrating clear examples, one or more figures may be described with reference to one or more other figures, but using the particular arrangement illustrated in the one or more other figures is not required in other embodiments.

FIG. 1 illustrates an example networked environment.

FIG. 2 illustrates and example device architecture.

FIG. 3A illustrates an example neural network architecture.

FIG. 3B illustrates an example transformer architecture.

FIG. 4 illustrates an example webpage having a learning engine generated content inserted.

FIG. 5 illustrates an example flow diagram.

### DETAILED DESCRIPTION

As similarly discussed above, large language models are becoming an increasingly important technology in information and content production. For example, large language models may be configured to perform a variety of language tasks, such as providing answers to questions, summarizing information, generating human-like text, performing text translations, writing scripts and stories, and/or the like. LLMs may thus be utilized in many different types of applications, such as chatbots, language processing, and content creation.

A large language model is a type of machine learning model that uses massive amounts of data to learn the statistical patterns of language, such as grammar, syntax, and vocabulary. A Generative Pretrained Transformer (GPT) is a form of large language model. By way of example, a large learning model may utilize neural networks and may be trained using unsupervised or unsupervised learning techniques.

Disadvantageously, large language models may not always provide the desired output, wasting computer resources and user time. LLMs suffer from such deficits because they are based on statistical patterns in large amounts of language data, and their output is no better than the data the LLMs were trained on. For example, LLMs are conventionally not trained using data personal to a user for whom content is to be generated and/or presented.

Further, large language models are typically trained and executed on systems remote from a user device via which a user query may be provided to the large language model and/or to which content generated by the large language model is to be presented. Thus, the large language model conventionally is not available to respond to queries or provide content in the absence of a network connection between the user device and the system hosting the large learning model. Further, even when networks are available, the response time may be disadvantageously slow as a result of the LLM having to service, at the same time, large numbers of requests from user devices and as a result of network traffic. Show slow response times may be unacceptable in applications where near instantaneous responses (e.g., less than a second) are needed, such as in injecting content into an ad space, as discussed herein.

Disclosed herein are techniques for improving the performance and output of large language models (e.g., GPT models) using data personal to a user for whom content is to be provided. Further, in order to enhance speed and availability, techniques are described for providing a local LLM on a user device.

Thus, an aspect of the present disclosure relates to utilizing a local LLM (e.g., hosted on and executed by a user device, such as a desktop computer, laptop computer, tablet computer, smartphone, wearable computer, game console, smart television, or other computer-based device). Another aspect of the present disclosure relates to configuring the local LLM to access local data of the user (e.g., copies of email, text messages, shopping history, purchase history, travel history, reading history, shopping lists, to-do lists, call history, voicemail, tagged photographs and/or videos, browsing history, and/or other user data) to enhance training of the LLM (e.g., via fine tuning or transfer learning) to thereby provide more relevant and useful content to the user (e.g., in response to user queries, or in the form of customized ads (which may be referred to as targeted content or TC) for products and services, which may be referred to as automatically directed content or ADC). Further, by utilizing a local LLM, speed is improved, network utilization is reduced, access is more reliable, and user data privacy is enhanced.

Optionally, an existing LLM may be downloaded to a user device, which may then fine tune the existing LLM using the local data of the user. Fine-tuning involves taking an existing pre-trained language model and further training it on specific data of the user to specialize the LLM for a particular task or domain, such as generating content relevant to the user. The fine-tuning process may comprise initializing the LLM with pre-trained weights and then continuing training on a smaller dataset, such as the user data, that is specific to the desired task. Optionally, one or more layers of the downloaded LLM may be deleted, one or more new layers may be added, and only the added layers are trained to reduce training time.

Optionally, in addition or instead, a transfer learning process may be utilized, wherein a pre-trained model is used as a starting point for a new model that is trained on a different task or domain. This technique involves reusing the weights and architecture of the existing LLM, and then training it on a new task using a smaller dataset (e.g., the user data). Optionally, the new model may be significantly smaller (utilizing much less device memory space) and faster than the original downloaded LLM as it is focused on a very specific task (e.g., generating or selecting content to be inserted into a webpage space). Optionally, once the new model is generated, the original (e.g., larger) model may be deleted from user device memory to thereby free up the memory for other uses.

For example, a pre-existing LLM may be a general purpose LLM pre-trained on a large corpus of text data, such as webpages, books, magazines, articles, and other publications using an unsupervised learning approach. During pre-training, the LLM may learn to predict the likelihood of the next word in a sequence of words given the previous words in the sequence.

Once downloaded to the user device, the LLM may be fine tuned using the user data, such as data (e.g., copies of email, text messages, shopping history, shopping lists, purchase history, to-do lists, call history, voicemail, tagged photographs and/or videos, browsing history, social networking posts, etc.) accessed from local, computer readable memory (e.g., a magnetic disc drive, a solid state drive, and/or other memory media). Optionally, some or all of such data may be accessed from servers remote from the user device, such as from servers hosting some or all of the foregoing user's data. As disclosed elsewhere herein, such user data may indicate a user's current interest and/or general interests. Based at least in part on the user data the LLM may generate content (e.g. text, graphic, still image, video image, and/or audio content) which should be of interest to the user. For example, optionally the LLM may only be trained using user data have a timestamp (e.g., a creation and/or last edited date) within a specified time frame (e.g., the last 4 hours, 8 hours, 24 hours, week, month, year, or other time frame). The content generated by the local LLM may also be based in part on data provided by a third party (e.g. an advertiser).

By way, if the recent user data indicates that the user has expressed an interest in vehicles over a window of time (e.g., as indicated via text and/or email messages to family members, via the user's browsing history, via a call history to car dealerships, etc. over the previous two weeks) and that the vehicle is for the user's 19 year old son (e.g., as determined by parsing user communication text), and if a third party has requested that a certain vehicle make and/or model be promoted, a content insertion engine may detect that the user is accessing a webpage (or other document) via a browser. The content insertion engine may determine if the webpage has a webpage area (e.g., above the fold, within content, sidebar, header, footer, pop-up, and/or overlay) that is eligible for the insertion of content generated by an LLM (where the content generated by the LLM may optionally include pre-existing third party content). If the content insertion engine detects such available webpage location the local LLM may generate content related to a vehicle to be promoted, where the content is customized for the user. For example, the LLM may select an existing image of a vehicle being promoted by the third party and that is popular among 20 year old men, may modify the vehicle image to include an image of the user's son driving the vehicle (where the image may be based on an image of the user's son obtained from the user's digital photo album), and may generate text including the user's name and the son's name (e.g., “Ed, can you imagine how existing your son Will would be to be driving the Acme Marathon sports sedan!). The local LLM or a local post-processing engine may size the generated content to fit in the corresponding webpage location.

TC spaces may be indicated in the website's HTML code using specific tags or classes, which TC networks and advertisers may use to target their TCs to appear in those specific areas. The content insertion engine may be configured to detect such TC space indications. For example, there are different types of codes that can be used to indicate TC placement in a webpage, depending on the TC platform or TC network being used. By way of illustration, TC placement in a webpage can be indicated using HTML code that specifies the location and size of the TC container. For example, a common HTML tag for TC placement is the <div> tag, which defines a container for the TC. By way of further example, TC placement in a webpage can be indicated using JavaScript code that creates and inserts the TC container into the webpage. By way of still further example, TC placement in a webpage can be indicated using code provided by a TC server. By way of additional example, CMS plugins (e.g., comprising HTML or JavaScript code) may be utilized that enable users to easily place TCs in their website without writing code. These plugins usually generate HTML or JavaScript code for the TC placement.

Optionally, the content insertion engine will only insert the LLM-generated content in a TC space in response to detecting that a webpage publisher has granted permission to do so. For example, such permission or prohibition thereof may be indicated by a corresponding tag, txt, or Disallow command inserted into the webpage HTML code. Optionally, if permission is not granted for the insertion of LLM generated content (generated using local user data), a conventional ad may be placed in the TC space.

By way of example, based on a user's travel history or user communications regarding future travels (as determined from user emails, text messages, social media postings, ticket purchases, car rentals, hotel reservations, recent or current reading materials, etc.), the disclosed systems and methods may generate and provide recommendations regarding future travels (e.g., travel destinations, hotels, car rentals restaurants, etc.). Such recommendations may be provided via the content insertion engine, which may insert the recommendations into a TC space (e.g., in the form of an advertisement or otherwise) and/or in response to a user query (e.g., a query submitted by the user via a query user interface, where the user query may ask for travel recommendations, optionally with limiting parameters, such as travel distance, flight time, length of stay, maximum budget, specified desired locations, specified undesirable locations, etc.). For example, the LLM may be configured to mimic the style of a travel agent or friend in providing such recommendations.

By way of further example, based on a user purchase history, user reading history (e.g., as may be determined from physical or electronic book/magazine purchases, browsing history, time spent on certain blogs, and/or the like) and/or user communications regarding future product or service purchases (as determined from user emails, text messages, social media postings, etc.), the disclosed systems and methods may generate recommendations and provide of suitable, compatible/interoperable products (e.g., compatible batteries for battery powered devices, compatible charging cables, compatible chargers, compatible cases, compatible remote controls, compatible speakers, compatible lenses, compatible software programs, compatible streaming services, compatible light bulbs, etc.). Such recommendations may be provided via the content insertion engine, which may insert the recommendations into a TC space (e.g., in the form of an ad or otherwise) and/or in response to a user query (e.g., a query submitted by the user via a query user interface, where the user query may ask for recommendations for products that are compatible with a specified product). For example, the local LLM may be configured to mimic the style of a sales person or friend in providing such recommendations.

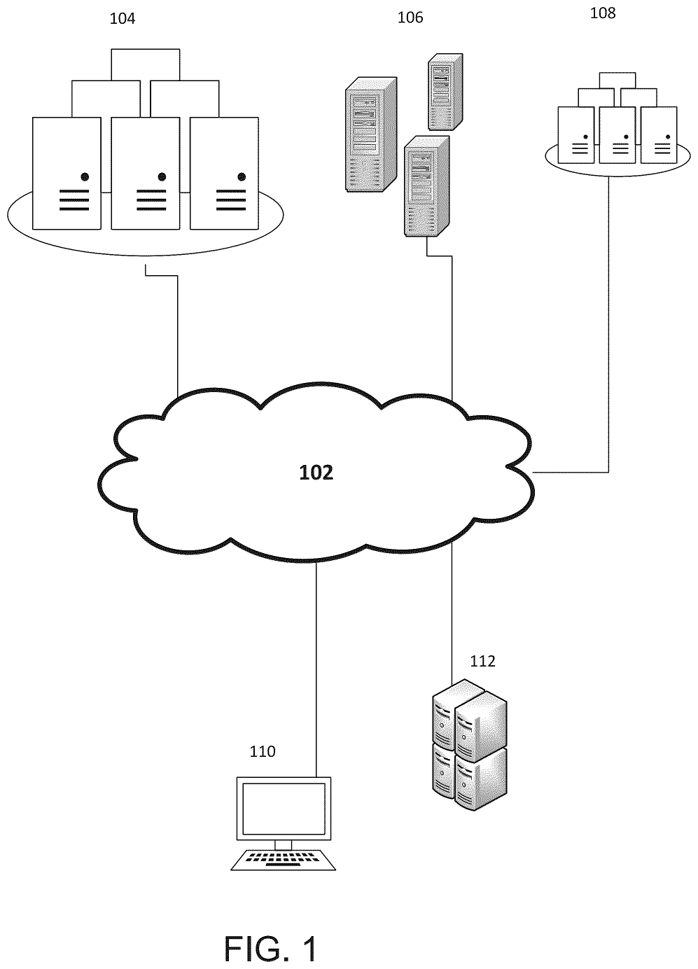

FIG. 1 illustrates an example environment which may be utilized with the methods and systems described herein. An LLM generation system 104 is configured to generate an LLM. The LLM generation system 104 may comprise a cloud system. With respect to the cloud-based computer system implementation, the cloud-based computer system may comprise a hosted computing environment that includes a collection of physical computing resources that may be remotely accessible, located at different facilities, and may be rapidly provisioned as needed (sometimes referred to as a “cloud” computing environment). Certain data described herein may optionally be stored using a data store that may comprise a hosted storage environment that includes a collection of physical data storage devices that may be remotely accessible and may be rapidly provisioned as needed (sometimes referred to as “cloud” storage).

The LLM system 104 may ingest vast amounts of text content and optionally image and sound content from a large variety of data stores, including webpages, books, magazines, articles, and other publications. Such data may be used to train the LLM system 104 (e.g., using an unsupervised or supervised learning approach).

Optionally, the LLM system 104 may comprise a text to image artificial intelligence (Al) engine that is configured to generate an image from a textual description. The text to image AI engine may process text received from a user (e.g., via a text field or file) to extract relevant features and convert it into a form that can be used by an image generation model. For example, the LLM system 104 may utilize natural language processing (NLP) to extract keywords, sentiment analysis to determine the mood, and/or semantic parsing to extract the structure of the input text. An image generation model may be configured to generate an image based on the processed text, using a neural network (e.g., an encoder-decoder recurrent neural network) that has been trained on large datasets of images. The generated image may be subjected to post-processing techniques, comprising image enhancement, style transfer, and/or image composition to thereby enhance the generated image quality and so that the generated image matches the input text as closely as possible. The generated image is optionally evaluated to ensure that it matches the input text, Optionally, structural similarity (SSIM) and/or peak signal-to-noise ratio (PSNR) are used to evaluate the similarity and quality of the generated image.

Optionally, in addition to or instead of generating text and/or images, the LLM generated by the LLM system 104 may be configured to select text and/or images to be presented. For example, in response to a query, the LLM system 104 may search through large amounts of information and identify the most relevant content. The LLM may optionally process and/or summarize the content.

The LLM may be downloaded over a network 102 (e.g., the Internet, wide area network, local area network, wireless network, and/or other network) from the LLM system 104 to a user device 110. The user device 110 may be configured with a local LLM enhancement engine, a TC space detection engine (e.g., configured to detect TC space in a webpage), and a content insertion engine. In addition, the user device 110 may host a browser configured to access websites and webpages.

As similarly discussed elsewhere herein, the LLM enhancement engine may be configured to train the downloaded LLM via data of the user associated with the user device. Such data may include copies of email, text messages, shopping history, item or service purchases, shopping lists, to-do lists, call history, voicemail, tagged photographs and/or videos, browsing history, social media postings, social media graphs, and/or other user data. Such user data may be used to fine tune or perform transfer learning with respect to the downloaded LLM to thereby generate and/or select more relevant and useful content to the user (e.g., in response to user queries, or in the form of customized TCs for products and services, which may be referred to as automatically directed content). Further, as discussed herein, by utilizing a local LLM, speed is improved, network utilization is reduced, access is more reliable, and user data privacy is enhanced.

The local LLM may be periodically updated and/or updated in response to certain events. For example, the local LLM may be updated in response to specific input by the user. By way of illustration, the user may provide preferences with respect to subject matter content for ads generated by and/or inserted by the local LLM. The preferences may indicate subject matter the user is interested in seeing and/or is not interested in seeing. For example, preferences may relate to vehicles, travel, restaurants, clothing, food, appliances, electronics, and/or the like. The LLM may then be trained accordingly to comply, in whole or in part, with the user preferences.

Similarly, the user can enter a list of content subject matter the user would like to be see in the local LLM generated or selected content (e.g., advertisements), and based on such user input, the local LLM may configure itself to generate or select future content that is more likely to include such subject matter. By way of illustrative example, the user may enter prompts such as:
Show me interesting accessories for my interests in woodworking, BBQ, care repair, and gardening.
Show me interesting articles on new scientific discoveries
Teach me about new things that I would want to know to be a good conversationalist

By way of further example, the LLM system 104 may update the local LLM periodically and/or in response to certain events (e.g., the availability of improved, more accurate and/or faster models). The LLM system 104 may push the new LLM to the user device 110 to replace the previous local LLM in whole or in part. The user device 110 may then utilize the new downloaded local LLM in place of the previous local LLM.

The local LLM may optionally self-optimize over time to improve its performance and capabilities. For example, the local LLM may expand its knowledge based by continuing to access user data as well as other data (e.g., websites, online magazines, blogs, journals, and/or the like) to obtain a broader understanding of language patterns, concepts, and/or facts.

The local LLM may be further trained on specific tasks that may be useful to the user. For example, the local LLM may monitor the user's interactions with content generated and/or selected by the local LLM, and based on such interactions optimize itself to generate more accurate and/or relevant content and responses to user queries. Such user interactions may include a user clicking on LLM generated and/or selected content to navigate to a relevant website, user purchases of an item being advertised in the LLM-generated or selected content, user viewing a video included in the LLM generated and/or selected content, and/or the like.

The local LLM may be further optimized by prompting the user to indicate whether given LLM-generated or selected content is of interest/liked by the user or is not of interest/disliked by the user, and based on the user's responses, the local LLM may configure itself to generate or select future content that is more likely to be of interest or liked by the user.

The user data may be stored in local memory (e.g., magnetic disc drive, optical disc drive, solid state memory, or other computer-readable tangible memory device) and/or may be accessed from one or more remote systems 112 (e.g., social networking system, email hosting systems, messaging systems, ecommerce systems, and/or other systems). The LLM enhancement engine may request permission to access all user data or selected user data (e.g., browsing history, emails, text messages, social networking accounts, purchase histories, etc.).

The user of the user device 110 may utilize the browser to access a webpage hosted by a publisher web server 106. The webpage may include indicators as to the location of TC space, and code indicating whether or not the LLM enhancement system may insert content into the TC space. The TC space detection engine may detect the location of TC space and determine whether the LLM enhancement system has permission to insert content at the TC space. The user device 110 may receive content from one or more TC servers 108 (e.g., in the event that the LLM enhancement system does not have permission to insert content at the TC space) to be inserted in a corresponding webpage TC space.

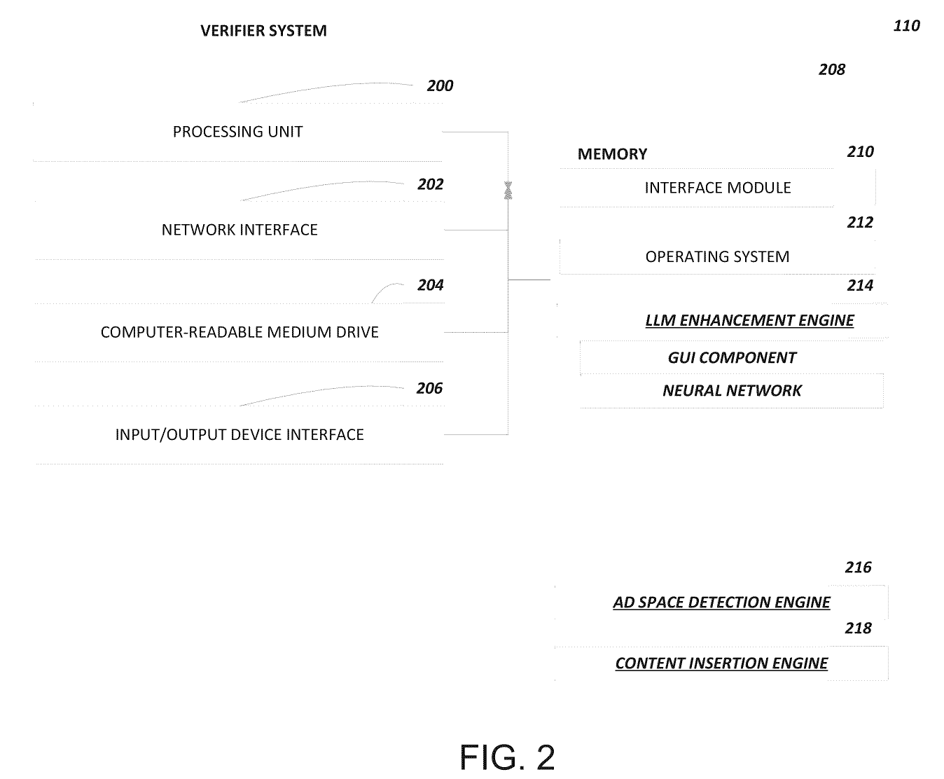

FIG. 2 is a block diagram illustrating example components of the user device 110. The example user device 110 includes an arrangement of computer hardware and software components that may be used to implement aspects of the present disclosure. Those skilled in the art will appreciate that the example components may include more (or fewer) components than those depicted in FIG. 2. Optionally, computer hardware and/or software components illustrated in FIG. 2 may be instead or also be included in other systems depicted in FIG. 1.

The user device 110 may include one or more processing units 200 (e.g., one or more general purpose processors and/or high speed graphics processors), one or more network interfaces 202, a non-transitory computer-readable medium drive 204, and an input/output device interface 206, all of which may communicate with one another by way of one or more communication buses. The network interface 202 may provide services described herein with connectivity to one or more networks or computing systems (e.g., LLM systems, webservers, TC servers, user data sources, etc.). The processing unit 200 may thus receive models and/or information (e.g., LLM models, webpages, TCs, user data, etc.), and/or instructions from other computing devices, systems, or services via a network, and may provide responsive data and/or execute instructions. The processing unit 200 may also communicate to and from memory 204 and further provide output information via the input/output device interface 206. The input/output device interface 206 may also accept input from one or more input devices, such as a keyboard, mouse, digital pen, touch screen, microphone, camera, etc.

The memory 208 may contain computer program instructions that the processing unit 200 may execute in order to implement one or more aspects of the present disclosure. The memory 208 generally includes RAM, ROM (and variants thereof, such as EEPROM) and/or other persistent or non-transitory tangible computer-readable storage media. An interface module 210 may provide access to data in the memory 200 and may enable data to be stored in the memory 200. The memory 200 may store an operating system 212 that provides computer program instructions for use by the processing unit 200 in the general administration and operation of an LLM Enhancement Engine 214, including its components.

The memory 208 may store user data, such as emails, text messages, Internet search histories, copies of social network postings and messages, product and service purchases, a user name, a user email address, a user phone number/SMS/text messaging address, geographical information (e.g., physical address, zip code, city, etc.), and/or other user data described herein.

Some or all of the data and content discussed herein may optionally be stored in a relational database, an SQL database, a NOSQL database, or other database type. Optionally, the memory 208 may include one or more external third party cloud-based storage systems.

The LLM Enhancement Engine 214 may include a GUI component that generates graphical user interfaces and processes user inputs (e.g., LLM queries from a user) and an LLM (e.g., neural network, such as an encoder-decoder recurrent neural network or a transfer network) configured to generate and/or select content to present to the user. The LLM, pre-trained, may have been downloaded from the LLM generation system 104 for further training by the LLM Enhancement Engine 214. The LLM may be trained using some or all of the user data described herein and/or other user data. In addition or instead, the LLM may be trained using data of a third party (e.g., an advertiser providing text and/or images of a product or service to be promoted, and/or targeting data for a desired viewer).

Optionally, the LLM Enhancement Engine 214 may comprise a transformer architecture that utilizes self-attention, which enables the model to selectively focus on different parts of the input sequence during the encoding process. The transformer architecture may comprise an encoder and a decoder, connected through a one or more multi-head attention and feedforward layers.

The encoder is configured to receive an input sequence and process it using multi-head self-attention, where the input sequence is transformed into a set of query, key, and value vectors. The query, key, and value vectors may be used to compute the attention scores between given positions in the sequence, enabling the model to identify the relevant (e.g., most relevant) portions of the input sequence for respective positions.

The decoder is configured to receive the encoder output and generate an output sequence. The decoder may also utilize multi-head attention, and may be further configured with an additional attention mechanism that enables the decoder to attend to the encoder output and to generate the output sequence using the relevant information from the input sequence.

The transformer architecture may comprise one or more feedforward layers, which apply a linear transformation followed by a non-linear activation function to the output of the attention layers. The feedforward layers facilitate further capture patterns in the input and output sequences.

The transformer may comprise a loss function that measures the difference between the predicted output sequence and the true output sequence. The transformer is configured to minimize or reduce the loss function output. Backpropagation may be utilized as part of the minimization process, where the gradients of the loss function with respect to the model parameters are calculated and used to update the model weights (e.g., associated with neural network layers).

The user device 110 may include a TC space detection engine 216 configured to detect the location of TC space and determine whether the LLM Enhancement Engine 214 has permission to insert content at the TC space. The user device 110 may comprise a content insertion engine 218 configured to insert the content generated and/or selected by the LLM Enhancement Engine 214 into the detected TC space.

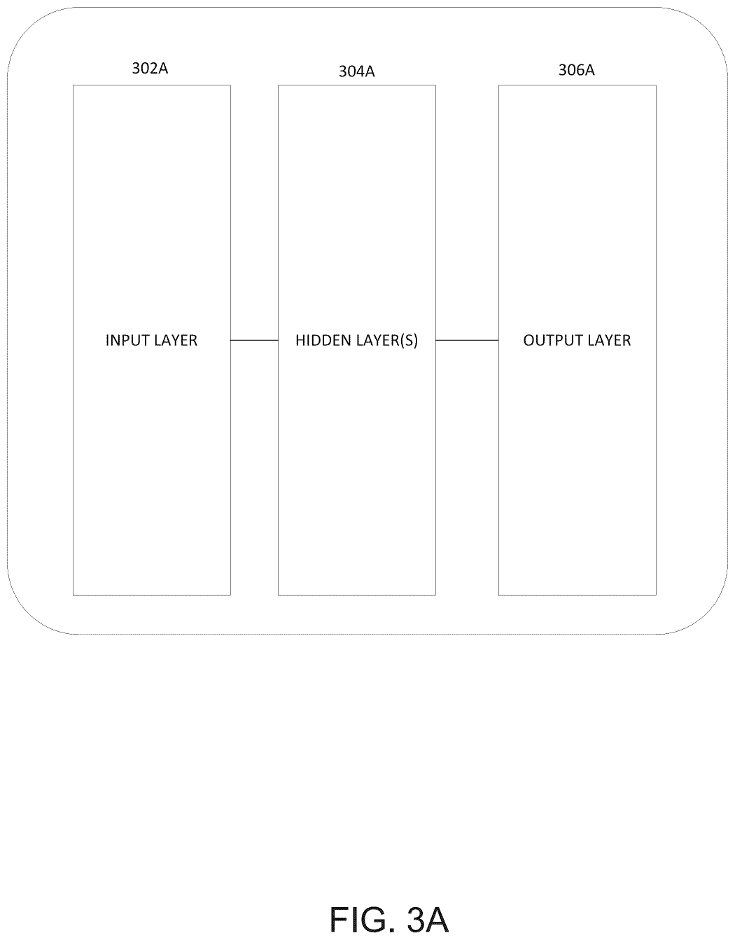

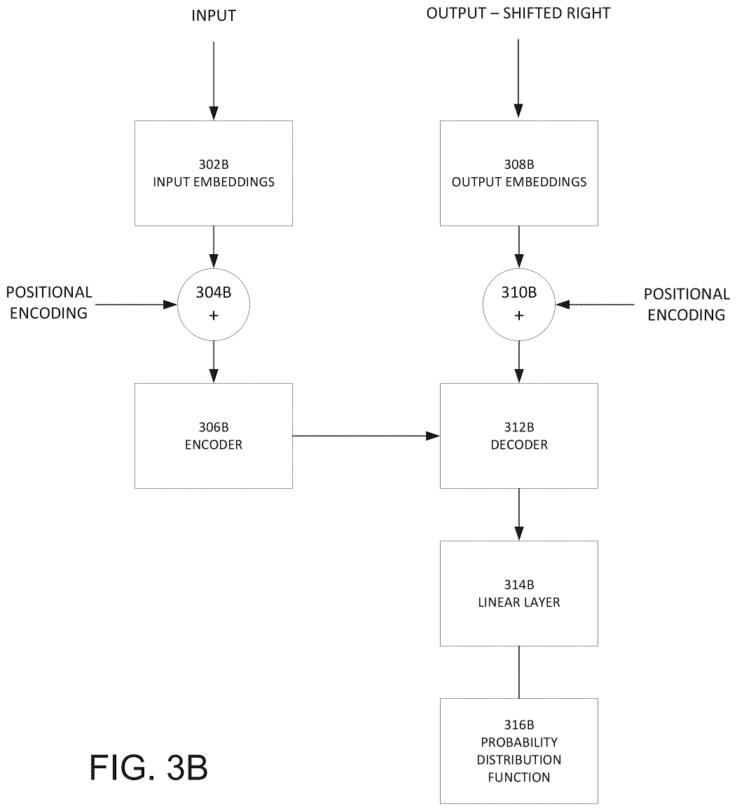

An example of a neural network configured to generate content based at least in part on user data, such as that described herein, is illustrated in FIG. 3A. The neural network may contain an input layer 302A, one or more hidden layers 304A, and an output layer 306A. The hidden layers 304A may be configured as convolutional layers, pooling layers, fully connected layers and/or normalization layers. For example, the neural network 304A may be configured with one or more pooling layers that combine outputs of neuron clusters at one layer into a single neuron in the next layer. Max pooling and/or average pooling may be utilized. Max pooling may utilize the maximum value from each of a cluster of neurons at the prior layer. Average pooling may utilize the average value from each of a cluster of neurons at the prior layer.

The neural network may have originally been downloaded from another system (e.g., an LLM system) and fine tuned using user data to generate and/or select content for a user. The training data may comprise user data. The neural network may be trained based using a supervised or unsupervised process. The neural network layer node weights may be adjusted using backpropagation based on an error function output with respect to the accuracy/relevance of the content generated and/or selected by the neural network, to thereby lower the error.

As previously discussed, a transformer model may be utilized to generate and/or select content for a user based at least in part on user data. Referring now to FIG. 3B, an example transformer model architecture is illustrated.

Block 302B is configured to receive tokens (a sequence of characters or subwords that represent a single unit of meaning within the input text) and generate input embeddings, where the input text is converted into a numerical format, sometimes referred to as input embeddings. The input embeddings represent words as numbers so as to be suitable for machine learning model processing. During training, the model learns how to create such embeddings so that similar vectors represent words with similar meanings.

Positional encoding may be utilized to encode the position of a given word in the input sequence as a set of numbers. The set of numbers may be input to transformer model 304B, in association with the input embeddings, to enable the model to understand the order of words in a sentence and generate grammatically correct and semantically meaningful output.

A neural network encoder 306B processes the received text and generates a series of hidden states that encapsulate the text context and the text meaning and that represent the input text at different levels of abstraction. Optionally, there may be a plurality of encoder layers. Optionally, the encoder tokenizes the input text into a sequence of tokens (e.g., words or sub-words), and applies one or more serial attention layers, such as individual words or sub-words. Advantageously, such attention layers enable the transformed model to selectively focus on different parts of the input sequence rather than having to treat each word or sub-word the same way, and further advantageously, enables relationships between inputs significantly distanced apart in the sequence to be determined. Such determined relationships facilitate language processing tasks.

The decoder 312B may be trained to predict a next word in a text sequence based on the prior words. This is optionally performed in part by shifting the output sequence to the right so that the decoder is only using the earlier words.

The output is converted to a numerical format, which may be referred to as output embeddings 308B. Positional encoding is optionally performed to facilitate the transformer model understanding of the order of words in a segment (e.g., a sentence). The set of numbers may be input 310B. A loss function, configured to calculate the difference between the transformer model's predictions and the actual values, may be utilized to adjust the transformer model to improve accuracy by reducing the difference between predictions and targets, and hence the error. During training, the output embeddings may compute the loss function and update the transformer model parameters to improve the transformer model performance. During an inference process, the output embeddings may generate output text by mapping the model's predicted probabilities of a given token to the corresponding token in the vocabulary.

The decoder 312B may receive the positionally encoded input representation and the positionally encoded output embeddings and, based on the foregoing, generates an output sequence. There may be one or more layers of decoders 312B. During the training process, the decoder learns how to predict the next word by examining the prior words. The decoder 312B may generate natural language text based on the input sequence and the context learned by the encoder.

A linear layer 314B may map the output embeddings from the decoder 312B to a higher-dimensional space to thereby transform the output embeddings from the decoder 312B into the original input space. A probability distribution function, 316B, such as the softmax function, may be applied to the output of the model's final layer, producing a vector of scores representing the likelihood of each possible output token in the vocabulary given the input sequence. The function may map these scores to a probability distribution over the vocabulary, with higher scores corresponding to higher probabilities.

By converting the output of the model into a probability distribution, the probability distribution function enables the transformer model to produce a prediction for the next token that is both informed by the input sequence and consistent with the language's syntax and semantics. This allows the model to generate fluent, coherent text that reflects the structure and style of the input text.

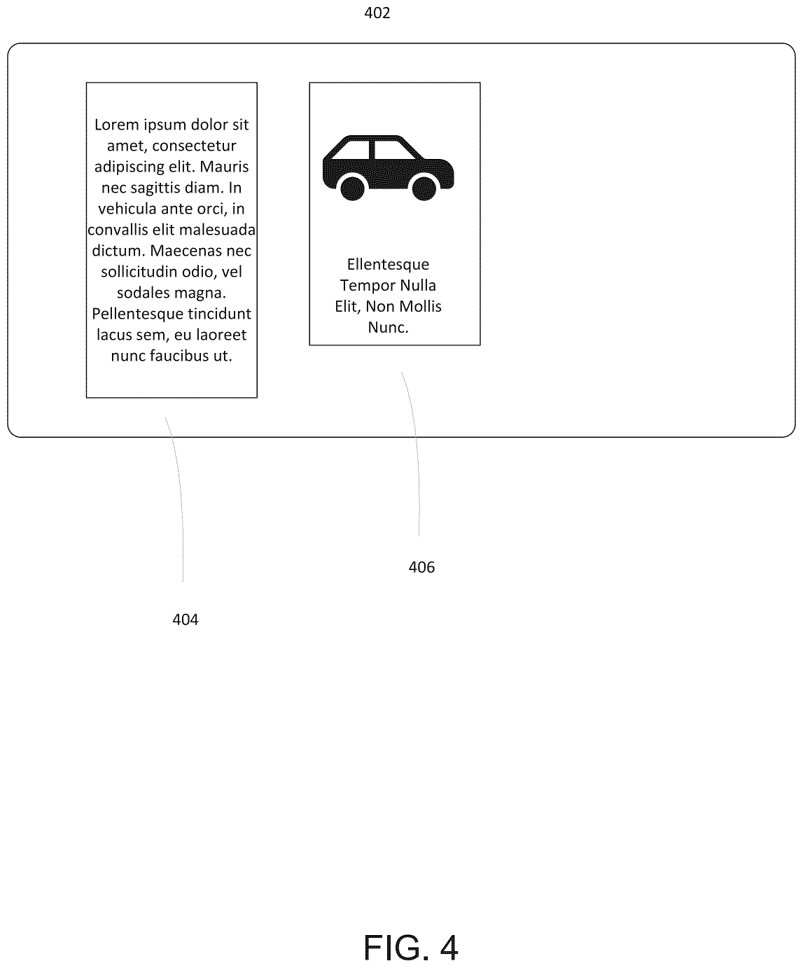

FIG. 4 illustrates an example webpage 402 comprising content 404 from a publisher and content 406 generated or selected by a large learning model as described herein. The content 406 may include on or more images (e.g., still or video images), text, graphics, and/or other content.

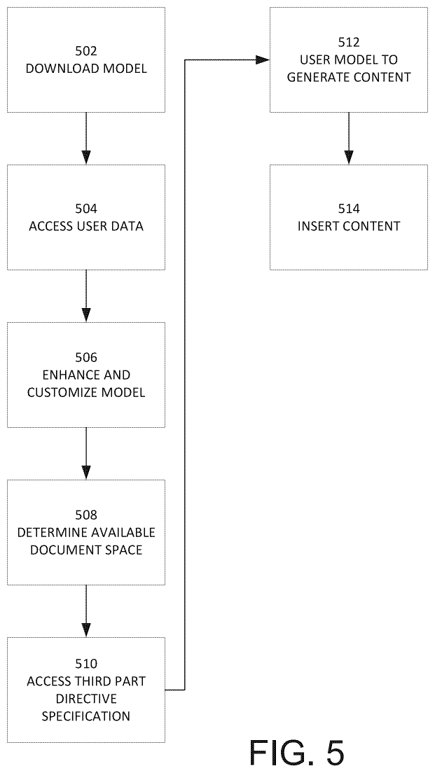

FIG. 5 illustrates an example process that may be executed by one or more systems disclosed herein. By way of example, the process may be executed in whole or in part by the disclosed user device. In this example, an LLM is trained to be used to generate and/or select content to be inserted into a webpage. Optionally, a text to image artificial intelligence (Al) engine may be trained as well.

At block 502, a trained large language model (LLM), such as that disclosed herein, is downloaded from a remote system to a user device (optionally, the text to image AI engine is downloaded as well). An application configured to further train the downloaded LLM (and optionally, the text to image AI engine) and/or to perform a transfer learning process (wherein the pre-trained downloaded LLM model and/or the text to image AI engine are used as a starting point for a new model that is then further trained) accesses user data at block 504. Optionally, the layer of the downloaded LLM that predicts the next word is deleted and a new layer is added, where just the new layer is trained to generate and/or select content for the user. Optionally, a user interface is first provided via which a user can grant or fail to grant access to one or more categories of user data (email, text messages, shopping history, purchases, shopping lists, to-do lists, call history, voicemail, tagged photographs and/or videos, browsing history, social media postings, social media graphs, etc.) to be used in the training process.

At block 506, some or all of the user data (and optionally third party data) may be utilized to train the downloaded model (or the new model subject to the transfer learning process) to thereby enhance and customize the LLM model.

At block 508, a determination is made that a user device browser is accessing a webpage, and a determination is made as to whether there is an appropriate webpage location in which content may be inserted (e.g., a TC space). At block 510, an indication (e.g., code, text, etc.) is accessed from the webpage indicating whether or not content generated and/or selected by the local LLM may be inserted in the webpage TC location. At block 512, the local LLM is used to generate and/or select content. Optionally, in addition to the user data, data of a third party, such as an advertiser, may be utilized in generating and/or selecting content.

At block 514, the content generated and/or selected by the local LLM is inserted in the corresponding webpage location and is rendered by the user device and displayed via a user device display, to the user.

Optionally and advantageously, the process of detecting a TC space, determining whether or not content generated and/or selected by the local LLM may be inserted therein, generating or select content, and inserting the generated and/or selected content into the TC space may be performed in substantially real time (e.g., 50 ms-1 section, 50 ms-3 seconds).

Thus, systems and methods are disclosed configured to receive a pre-trained large learning model via the network interface, access user data stored locally, train the pre-trained large learning model using the locally stored user data to provide an enhanced local large learning model, detect that a browser hosted by the computer system is accessing a webpage, identify a webpage space configured to receive third-party content, examine the webpage to determine if content provided by the enhanced, local large learning model may be rendered at the webpage space, and causing content generated or selected by the enhanced, local large learning model to be rendered at the webpage space. The enhanced local large learning model may comprise a neural network.

An aspect of the present disclosure relates to a computer system associated with a user, the computer system comprising: a network interface; at least one processing device operable to: receive a pre-trained large learning model via the network interface; access user data stored locally; train the pre-trained large learning model using the locally stored user data to provide an enhanced local large learning model; detect that a browser hosted by the computer system is accessing a document; identify a document space configured to receive third-party content; examine the document to determine if the computer system is permitted to insert content provided by the enhanced, local large learning model; at least partly in response to determining that the computer system is permitted to insert content provided by the enhanced, local large learning model, cause content generated or selected by the enhanced, local large learning model to be rendered at the document space configured to receive third-party content.

Optionally, training the pre-trained large learning model using the locally stored user data to provide the enhanced local large learning model, further comprises performing transfer learning. Optionally, an encoder configured to receive an input sequence and process it using multi-head self-attention, where the input sequence is transformed into a set of query, key, and value vectors used to compute attention scores between respective given positions in the input; a decoder configured to receive an output of the encoder and to generate an output sequence, the decoder configured to utilize multi-head attention and to generate an output sequence using relevant information from the input sequence. Optionally, the locally stored user data comprises user electronic communications. Optionally, the content generated or selected by the enhanced, local large learning model comprises text and image content. Optionally, identifying the document space configured to receive third-party content, examining the document to determine if the computer system is permitted to insert content provided by the enhanced, local large learning model, and causing content generated or selected by the enhanced, local large learning model to be rendered at the document space configured to receive third-party content, is performed in substantially real time. Optionally, examining the document to determine if the computer system is permitted to insert content provided by the enhanced, local large learning model further comprises determining a presence of a first tag, a first txt, or a first Disallow command inserted into HTML code of the document.

An aspect of the present disclosure relates to a computer implemented method, the method comprising: receiving, at a computer system, a pre-trained large learning model over a network interface; storing the pre-trained large learning model in local non-tangible memory; accessing user data stored locally on the computer system; using the pre-trained large learning model and the locally stored user data to provide an enhanced local large learning model; detecting that a browser hosted by the computer system is accessing a document; identifying a document space configured to receive third-party content; examining the document to determine if content provided by the enhanced, local large learning model is permitted to be inserted into the document space configured to receive third-party content; at least partly in response to determining that content provided by the enhanced, local large learning model is permitted to be inserted into the document space configured to receive third-party content, enabling content generated or selected by the enhanced, local large learning model to be rendered at the document space configured to receive third-party content.

Optionally, training the pre-trained large learning model using the locally stored user data to provide the enhanced local large learning model, further comprises performing transfer learning. Optionally, the large learning model comprises: an encoder configured to receive an input sequence and process it using multi-head self-attention, where the input sequence is transformed into a set of query, key, and value vectors used to compute attention scores between respective given positions in the input; and a decoder configured to receive an output of the encoder and to generate an output sequence, the decoder configured to utilize multi-head attention and to generate an output sequence using relevant information from the input sequence. Optionally, the locally stored user data comprises user electronic communications. Optionally, the content generated or selected by the enhanced, local large learning model comprises text and image content. Optionally, identifying the document space configured to receive third-party content, examining the document to determine if the computer system is permitted to insert content provided by the enhanced, local large learning model, and causing content generated or selected by the enhanced, local large learning model to be rendered at the document space configured to receive third-party content, is performed in substantially real time. Optionally, examining the document to determine if the computer system is permitted to insert content provided by the enhanced, local large learning model further comprises determining a presence of a first tag, a first txt, or a first Disallow command inserted into HTML code of the document.

An aspect of the present disclosure relates to a computer system associated with a user, the computer system comprising: a network interface; at least one processing device operable to: receive a pre-trained large learning model via the network interface; access user data stored locally; use the pre-trained large learning model and the locally stored user data to provide an enhanced local large learning model; detect that a browser hosted by the computer system is accessing a document; identify a document space configured to receive third-party content; and cause content generated or selected by the enhanced, local large learning model to be rendered at the document space configured to receive third-party content.

Optionally, training the pre-trained large learning model using the locally stored user data to provide the enhanced local large learning model, further comprises performing transfer learning. Optionally, the large learning model comprises: an encoder configured to receive an input sequence and process it using multi-head self-attention, where the input sequence is transformed into a set of query, key, and value vectors used to compute attention scores between respective given positions in the input; and a decoder configured to receive an output of the encoder and to generate an output sequence, the decoder configured to utilize multi-head attention and to generate an output sequence using relevant information from the input sequence. Optionally, the locally stored user data comprises user electronic communications. Optionally, the content generated or selected by the enhanced, local large learning model comprises text and image content. Optionally, identifying the document space configured to receive third-party content, examining the document to determine if the computer system is permitted to insert content provided by the enhanced, local large learning model, and causing content generated or selected by the enhanced, local large learning model to be rendered at the document space configured to receive third-party content, is performed in substantially real time. Optionally, examining the document to determine if the computer system is permitted to insert content provided by the enhanced, local large learning model further comprises determining a presence of a first tag, a first txt, or a first Disallow command inserted into HTML code of the document.

Systems and modules described herein may comprise software, firmware, hardware, or any combination(s) of software, firmware, or hardware suitable for the purposes described. Software and other modules may reside and execute on servers, workstations, personal computers, computerized tablets, PDAs, and other computing devices suitable for the purposes described herein. Software and other modules may be accessible via local computer memory, via a network, via a browser, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, interactive voice response, command line interfaces, and other suitable interfaces.

Further, processing of the various components of the illustrated systems can be distributed across multiple machines, networks, and other computing resources, or may comprise a standalone system. Two or more components of a system can be combined into fewer components. Various components of the illustrated systems can be implemented in one or more virtual machines, rather than in dedicated computer hardware systems and/or computing devices. Likewise, the data repositories shown can represent physical and/or logical data storage, including, e.g., storage area networks or other distributed storage systems. Moreover, in some embodiments the connections between the components shown represent possible paths of data flow, rather than actual connections between hardware. While some examples of possible connections are shown, any of the subset of the components shown can communicate with any other subset of components in various implementations.

Embodiments are also described above with reference to flow chart illustrations and/or block diagrams of methods, apparatus (systems) and computer program products. Each block of the flow chart illustrations and/or block diagrams, and combinations of blocks in the flow chart illustrations and/or block diagrams, may be implemented by computer program instructions. Such instructions may be provided to a processor of a general purpose computer, special purpose computer, specially-equipped computer (e.g., comprising a high-performance database server, a graphics subsystem, etc.) or other programmable data processing apparatus to produce a machine, such that the instructions, which execute via the processor(s) of the computer or other programmable data processing apparatus, create means for implementing the acts specified in the flow chart and/or block diagram block or blocks. These computer program instructions may also be stored in a non-transitory computer-readable memory that can direct a computer or other programmable data processing apparatus to operate in a particular manner, such that the instructions stored in the computer-readable memory produce an article of manufacture including instruction means which implement the acts specified in the flow chart and/or block diagram block or blocks. The computer program instructions may also be loaded to a computing device or other programmable data processing apparatus to cause operations to be performed on the computing device or other programmable apparatus to produce a computer implemented process such that the instructions which execute on the computing device or other programmable apparatus provide steps for implementing the acts specified in the flow chart and/or block diagram block or blocks.

While the phrase “click” may be used with respect to a user selecting a control, menu selection, or the like, other user inputs may be used, such as voice commands, text entry, gestures, etc. User inputs may, by way of example, be provided via an interface, such as via text fields, wherein a user enters text, and/or via a menu selection (e.g., a drop down menu, a list or other arrangement via which the user can check via a check box or otherwise make a selection or selections, a group of individually selectable icons, etc.). When the user provides an input or activates a control, a corresponding computing system may perform the corresponding operation. Some or all of the data, inputs and instructions provided by a user may optionally be stored in a system data store (e.g., a database), from which the system may access and retrieve such data, inputs, and instructions. The notifications and user interfaces described herein may be provided via a Web page, a dedicated or non-dedicated phone or mobile application, computer application, a short messaging service message (e.g., SMS, MMS, etc.), instant messaging, email, push notification, audibly, via haptic feedback, and/or otherwise.

The user terminals described herein may be in the form of a mobile communication device (e.g., a cell phone), laptop, tablet computer, interactive television, game console, media streaming device, head-wearable display, networked watch, etc. The user terminals may optionally include displays, user input devices (e.g., touchscreen, keyboard, mouse, microphone, camera, touch pad, etc.), network interfaces, etc.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention. These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

To reduce the number of claims, certain aspects of the invention are presented below in certain claim forms, but the applicant contemplates other aspects of the invention in any number of claim forms. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application, in either this application or in a continuing application.

What is claimed is:

1. A computer system associated with a user, the computer system comprising:
a network interface;
at least one processing device operable to:
receive a pre-trained large learning model via the network interface;
access user data stored locally;
train the pre-trained large learning model using the locally stored user data to provide an enhanced local large learning model;
detect that a browser hosted by the computer system is accessing a document;
identify a document space configured to receive third-party content;
examine the document to determine if the computer system is permitted to insert content provided by the enhanced, local large learning model;
at least partly in response to determining that the computer system is permitted to insert content provided by the enhanced, local large learning model, cause content generated or selected by the enhanced, local large learning model to be rendered at the document space configured to receive third-party content.

2. The computer system as defined in claim 1, wherein training the pre-trained large learning model using the locally stored user data to provide the enhanced local large learning model, further comprises performing transfer learning.

3. The computer system as defined in claim 1, wherein the large learning model comprises:
an encoder configured to receive an input sequence and process it using multi-head self-attention, where the input sequence is transformed into a set of query, key, and value vectors used to compute attention scores between respective given positions in the input;
a decoder configured to receive an output of the encoder and to generate an output sequence, the decoder configured to utilize multi-head attention and to generate an output sequence using relevant information from the input sequence.

4. The computer system as defined in claim 1, wherein the locally stored user data comprises user electronic communications.

5. The computer system as defined in claim 1, wherein the content generated or selected by the enhanced, local large learning model comprises text and image content.

6. The computer system as defined in claim 1, wherein identifying the document space configured to receive third-party content, examining the document to determine if the computer system is permitted to insert content provided by the enhanced, local large learning model, and causing content generated or selected by the enhanced, local large learning model to be rendered at the document space configured to receive third-party content, is performed in substantially real time.

7. The computer system as defined in claim 1, wherein examining the document to determine if the computer system is permitted to insert content provided by the enhanced, local large learning model further comprises determining a presence of a first tag, a first txt, or a first Disallow command inserted into HTML code of the document.

8. A computer implemented method, the method comprising:
receiving, at a computer system, a pre-trained large learning model over a network interface;
storing the pre-trained large learning model in local non-tangible memory;
accessing user data stored locally on the computer system;
using the pre-trained large learning model and the locally stored user data to provide an enhanced local large learning model;
detecting that a browser hosted by the computer system is accessing a document;
identifying a document space configured to receive third-party content;
examining the document to determine if content provided by the enhanced, local large learning model is permitted to be inserted into the document space configured to receive third-party content;
at least partly in response to determining that content provided by the enhanced, local large learning model is permitted to be inserted into the document space configured to receive third-party content, enabling content generated or selected by the enhanced, local large learning model to be rendered at the document space configured to receive third-party content.

9. The computer-implemented as defined in claim 8, wherein training the pre-trained large learning model using the locally stored user data to provide the enhanced local large learning model, further comprises performing transfer learning.

10. The computer-implemented as defined in claim 8, wherein the large learning model comprises:
an encoder configured to receive an input sequence and process it using multi-head self-attention, where the input sequence is transformed into a set of query, key, and value vectors used to compute attention scores between respective given positions in the input;
a decoder configured to receive an output of the encoder and to generate an output sequence, the decoder configured to utilize multi-head attention and to generate an output sequence using relevant information from the input sequence.

11. The computer-implemented as defined in claim 8, wherein the locally stored user data comprises user electronic communications.

12. The computer-implemented as defined in claim 8, wherein the content generated or selected by the enhanced, local large learning model comprises text and image content.

13. The computer-implemented as defined in claim 8, wherein identifying the document space configured to receive third-party content, examining the document to determine if the computer system is permitted to insert content provided by the enhanced, local large learning model, and causing content generated or selected by the enhanced, local large learning model to be rendered at the document space configured to receive third-party content, is performed in substantially real time.

14. The computer-implemented as defined in claim 8, wherein examining the document to determine if the computer system is permitted to insert content provided by the enhanced, local large learning model further comprises determining a presence of a first tag, a first txt, or a first Disallow command inserted into HTML code of the document.

15. A computer system associated with a user, the computer system comprising:
a network interface;
at least one processing device operable to:
receive a pre-trained large learning model via the network interface;
access user data stored locally;
use the pre-trained large learning model and the locally stored user data to provide an enhanced local large learning model;
detect that a browser hosted by the computer system is accessing a document;
identify a document space configured to receive third-party content; and
cause content generated or selected by the enhanced, local large learning model to be rendered at the document space configured to receive third-party content.

16. The computer system as defined in claim 15, wherein training the pre-trained large learning model using the locally stored user data to provide the enhanced local large learning model, further comprises performing transfer learning.

17. The computer system as defined in claim 15, wherein the large learning model comprises:
an encoder configured to receive an input sequence and process it using multi-head self-attention, where the input sequence is transformed into a set of query, key, and value vectors used to compute attention scores between respective given positions in the input;
a decoder configured to receive an output of the encoder and to generate an output sequence, the decoder configured to utilize multi-head attention and to generate an output sequence using relevant information from the input sequence.

18. The computer system as defined in claim 15, wherein the locally stored user data comprises user electronic communications.

19. The computer system as defined in claim 15, wherein the content generated or selected by the enhanced, local large learning model comprises text and image content.

20. The computer system as defined in claim 15, wherein identifying the document space configured to receive third-party content, examining the document to determine if the computer system is permitted to insert content provided by the enhanced, local large learning model, and causing content generated or selected by the enhanced, local large learning model to be rendered at the document space configured to receive third-party content, is performed in substantially real time.

21. The computer system as defined in claim 15, wherein examining the document to determine if the computer system is permitted to insert content provided by the enhanced, local large learning model further comprises determining a presence of a first tag, a first txt, or a first Disallow command inserted into HTML code of the document.
